(19) United States
(12) Patent Application Publication
(10) Pub. No.: US 2012/0283087 A1
(43) Pub. Date: Nov. 8, 2012

(54) SYNTHETIC QUARTZ COMPOSITION AND PRODUCTION PROCESS THEREFOR

(76) Inventors: Wesley Moore, San Francisco, CA (US); Phil Chang, San Francisco, CA (US)

(21) Appl. No.: 13/148,940

(22) PCT Filed: Feb. 10, 2010
(86) PCT No.: PCT/US10/23781

§ 371 Date: Mar. 6, 2012

(30) Foreign Application Priority Data
Feb. 10, 2009 (US) 12/368-562

(51) Int. Cl. C04B 30/02; B28B 1/08

(52) U.S. Cl. 501/32; 501/154; 264/69

(57) ABSTRACT

A synthetic quartz composition having improved tensile strength, compression strength and bending strength comprising up to 90% quartz stone, from 5 to 90% quartz powder, from 0.1 to 20% resin, from 1 to 25% fiber, from 0.1 to 5% coupling agent, from 0.1 to 5% curing agent, up to 70% glass chip, up to 70% mirror chip, up to 5% pigment, up to 5% shell chip, and up to 5% metal flake, by weight, may be produced in panels and molded shapes such as containers.

### TECHNICAL FIELD

This new invention is directed to an improved synthetic quartz product and a production process therefor.

### BACKGROUND ART

Synthetic quartz, sometimes called artificial marble, has very favorable chemical and physical properties including resistance to acids, corrosion, high temperatures, wear, impact, compression, bending and infiltration. It is also very easy to install and keep clean. Synthetic quartz can be manufactured in many patterns including simulated marble or granite, can be given features like a natural marble-like smoothness, granitic strength, and ceramic luster, and can be formed into many shapes. Handsome and practical synthetic quartz is an ideal modern architectural decorative material.

The major raw materials generally used in the production of synthetic quartz under current production techniques are quartz, quartz powder and resin. Resin is used to combine all the materials into a very strong and solid finished product. Resins commonly used are unsaturated polyester resin, epoxy, phenolic resin, acrylic resin and polyurethane resin.

Despite its many advantages, studies have found that synthetic quartz manufactured according to existing formulas and technologies does not meet ASTM International (ASTM) quality standards for natural quartz such as for tensile strength, compressive strength and flexural strength. Consequently, applications for synthetic quartz have heretofore been limited.

### DISCLOSURE OF INVENTION

The invention is directed to providing an improved synthetic quartz product having superior physical properties achieved by adding fiber particles to the raw materials conventionally use to produce synthetic quartz. In particular, the improved synthetic quartz has tensile strength, compression strength and bending strength ratings that meet or exceed ASTM standards for natural quartz.

According to the invention, improved synthetic quartz comprises a combination of the following elements in the percentages indicated according to weight:

quartz stones 0-90%,

quartz powder 5-90%,

resin 0.1-20%,

fiber 1-25%,

coupling agent 0.1-5%,

curing agent 0.1-5%,

glass chip 0-70%,

mirror chip 0-70%,

pigment 0-5%,

shell chip 0-5% and

metal flake 0-5%.

One embodiment of the invention having good physical properties has the following formulation (unless otherwise specified, all percentages indicated the percent by weight of the indicated to total weight of the combination):

quartz stone 30-35%,

quartz powder 45-50%,

resin 6-8%,

fiber 3-5%,

coupling agent 0.1-1%,

curing agent 0.1-0.5%,

glass chip 15-20%, and

pigment 0.1-1%.

Another embodiment of the invention having better physical properties has the following formulation:

quartz stone 5-6%,

quartz powder 32-33%,

glass chip 51-55%,

fiber 5-7%,

resin 6.5-7%,

coupling agent 0.1-0.2%,

curing agent 0.1-0.2%, and

pigment 0.1-0.5%.

A third embodiment of the invention having excellent physical properties has the following formulation:

quartz stone 47%,

quartz powder 41.65%,

resin 8%,

fiber 3%,

coupling agent 0.1%,

curing agent 0.05%, and

pigment 0.2%.

A fourth embodiment of the invention also having excellent physical properties has the following formulation:

quartz powder 32.65%,

glass chip 55%,

resin 7%,

fiber 5%,

coupling agent 0.1%,

curing agent 0.05%, and

pigment 0.2%.

The particle size of the quartz powder according to the invention is from 0.1 to 20 mm, but the most frequently used size is between 0 and 2 mm. The best size are 0-1 mm, 0-2 mm, 1-2 mm, 3-5 mm, 5-8 mm and 8-12 mm, and pureness above 80. The purpose of quartz powder is to act as a filler. If the particle size is too big, the quartz powder will not function as a filler; conversely, if the particle size is too small, the quartz powder will absorb too much resin resulting in an undesirable increase in cost. Tests have determined that a particle size between 300 and 2000 mesh strikes a good balance between performing well as filler and keeping costs to a practicable minimum. The size of the glass chip, shell chip and metal flake are each 0.1-25 mm.

The addition of fiber into the material improves tensile strength, compressive strength and bending strength. According to the invention suitable fibers are one or a combination of fiberglass, carbon fiber, basalt fiber and boron fiber; however, it will be appreciated by those of skill in the art that other fiber building materials may be substituted it correspondingly favorable properties result.

Resin acts as a binding agent. When the curing agent is introduced to a mixture of resin in its liquid phase, quartz powder and other ingredients, the resin hardens into a solid such that the resulting mixture cures into a high density, high strength solid quartz product. Suitable resins are one or a combination of unsaturated polyester resin, epoxy, phenolic resin, acrylic resin and polyurethane resin, but it will be understood that other binding resins having similar binding properties may be used.

The invention described curing agents are the field of conventional curing agents. Curing agents reinforce and induce the resin to cure into a solid condition. Suitable curing agents according to the invention are one or a multiple of methyl ethyl ketone peroxide (MEKP) and/or fat multi-amines. Suitable fat multi-amines according to the invention include ethylenediamine, diethylenetriamine, triethylenebutamine, butaethylenepentamine, polyethylenepolyamine, dipropenetriamine, dimethylaminepropylamine, diethylaminepropylamine, 3-methyl-6-diamine, dihexyltriamine, tert-butyl peroxy-2-ethylhexanoate (TBPO), hexamethylenediamine. It will be recognized by those of skill in the art that other curing agents may be used alone or in combination with MEKP and the above fat multi-amines as curing agents.

The coupling agent increases the particle surface roughness and provides the bonding force between two quartz particles. It has been determined that a RSiX₃ R which stands for amino(-NH₂), sulfhydryl (HS—), vinyl (CH₂:CH), epoxy, cyano(N≡C—), methacryloxyl (CH₂:C(CH₃)CO) groups. These groups have stronger reactivity with resins. X stands for the hydrolysis alkoxy (e.g., methoxy and ethoxy). It has been determined that a suitable silane coupling agent is γ-methacryloxylpropyl-trimethylsilicane, γ-(2,3-epoxypropane)propyl-trimethylsilicane, N-β(aminoethyl)-γ-aminoproplymethyldimethoxysilicane, N-(β-aminoethyl)-γ-aminoproplytrim-ethylsilicane.

Pigments suitable for use in the combination according to the invention are ferric pigment (e.g., iron black, iron yellow and iron red), phthalocyanine pigments (e.g., phthalocyanine green blue and phthalocyanine green), titanium pigment (e.g., titanium dioxide) or carbon pigment (e.g., carbon black, carbon yellow and carbon red). Other pigments conventionally used in the manufacture of synthetic quartz are intended to fall within the scope of the invention.

The addition of chips to the combination results in improved aesthetics and pleasing visual effects. Chips appropriate for use in the combination include mirror chips, shell chips and metal flakes each of which can be derived from recycled materials.

Additives suitable for use in the combination according to the invention include alumina hydrate, tert-butyl, and promoter cobalt styrene.

The production process involves a progression through a number of systems and operations as follows: Raw materials preparation system→batching system→mixing system→distribution system→vacuum, vibration and pressing system→curing.

The improved synthetic quartz can be manufactured in panels, containers and other shapes limited only by available molds. Panels of the improved synthetic quartz are manufactured using a process that mixes the above materials in a pot in a vacuum, vibrating the mixture, pressing the mixed material into a desired shape and thickness, and letting it cure.

Containers are manufactured using a production process that mixes the

The temperature range during the curing period is 10-200° C., but applicants have determined that suitable temperature ranges are 15-35° C. or 120-150° C. depending on the composition of the mixture.

The above process produces a blank part. Secondary work methods are then used to finish the blank part such as smoothing the bottom side, e.g., by sanding or grinding, releasing the mold, controlling thickness, and polishing the surface.

Addition of fiber to synthetic quartz formulations has the distinct advantage that it reinforces the product matrix and improves the product's physical properties such as tensile strength, compression strength and bending strength. Applications for the improved synthetic quartz are, therefore, significantly expanded. Moreover, upwards of fifty percent of the materials used in formulations according to the invention can be recycled materials, such as glass or mirror chips, making the invention an environmentally friendly product.

The following examples describe specific embodiments of the invention but are not intended to limit its scope. It has been determined that the following materials purchased from the companies indicated are suitable for use according to the invention:

Resin: Unsaturated polyester resin, available from Ashland Specialty Composite Polymers, 5200 Blazer Parkway, Dublin, Ohio 43017 or DSM; epoxy available, from CIBA Corporation: 540 White Plains Road, P.O. Box 2005, Tarrytown, 10591, N.Y.; polyurethane resin, available from Huntsman Advanced Materials, phenolic resin available from Plastics Engineering Company, of Sheboygan, Wis., Mitsui & Co. Ltd. in Japan, or Bakelite AG in Germany; acrylic resin available from Evalite International Co. Ltd., Suite 1001a, 10th, Tower 1, Hong Kong.

Coupling agent: Γ-methacryloxypropyltrimethoxysilane available from Zibo Xhuliang Rubber I/e Co., Ltd., located in China, under the brand name KH-570, Osi Specialties North America, located in South Charleston, W. Va., Dow Corning under the brand name Z-6030, Toray Group, located in Japan, under the brand name SH6030, or Anhui Herrman Impex Co., Ltd., located in China, under the brand name KBM-503.

Fiber: Fiberglass, available from CPIC Fiberglass Chongqing Polycomp International Corp., Dadukou Dist., Chongqing, P.R. China.; carbon fiber, available from TOHO TENAX Co., Ltd., Kasumigaseki Common Gate West Tower, 3-2-1 Kasumigaseki, Chiyoda-ku,Tokyo, Japan 100-8585; basalt fiber, available from Hengdian Group Russia & Gold Basalt Fiber Co., No. 258, Songxing West Rd., Shanghai, Baoshan District, P.R. China 200940; and boron fiber, available from Beijing Oriental New Materials Technology Co.

### EXAMPLES

The production processes used for producing each of the above examples are discussed below:

### Example 1

| Material Type | Particular Material | Size | Percent by weight |
|---|---|---|---|
| quartz powder | | 500 mesh | 90 |
| resin | UP | | 9 |
| fiber | glass | | 0.2 |
| coupling agent | A-174 | | 0.4 |
| curing agent | MEKP | | 0.4 |

Combine the ingredients indicated in Example 1 according to the given percentages. Deposit the mix onto the mold in as uniform a thickness as possible. Subject the molded material to a vacuum calibrated to facilitate removal of air bubbles from the mixture. Vibrate the mixture to further assist removal of air bubbles and to settle the material in the mold. Press the material to compact it to a density, which when cured, will have the desired physical properties. While continuing the press the material in the mold, cure the material at 10° C. to create blanks. Finish the blanks by grinding the bottom side, turning them over, sanding the top side to a desired uniform thickness, and polishing. The finished product is a high density, super hard synthetic quartz panel.

### Example 2

| Material Type | Particular Material | Size | Percent by weight |
|---|---|---|---|
| quartz stone | | 6 mm | 90 |
| quartz powder | | 700 mesh | 5 |
| resin | PU | | 4 |
| fiber | basalt | | 0.2 |
| coupling agent | KBM-503 | | 0.4 |
| curing agent | dihexylamine | | 0.4 |

### Example 3

| Material Type | Particular Material | Size | Percent by weight |
|---|---|---|---|
| quartz powder | | 900 mesh | 6 |
| resin | epoxy | | 20 |
| fiber | glass | | 1 |
| coupling agent | SH6030 | | 0.5 |
| curing agent | dihexylamine | | 2.5 |
| glass chip | | 7 mm | 70 |

Combine the ingredients indicated in Examples 2 and 3 according to the given percentages. Manufacture the mixture into panels according to the procedures discussed above in connection with Example 1, except that the mixture should be cured at 25° C. The finished product is a high density, super hard synthetic quartz panel.

### Example 4

| Material Type | Particular Material | Size | Percent by weight |
|---|---|---|---|
| quartz powder | | 1000 mesh | 5 |
| resin | phenolic | | 0.1 |
| fiber | basalt | | 24.7 |
| coupling agent | Z-6030 | | 0.1 |
| curing agent | Modified | | 0.1 |
| | dihexylamine | | |
| mirror chip | | 8 mm | 70 |

Combine the ingredients indicated in Example 4 according to the given percentages. Manufacture the mixture into panels according to the procedures described above in connection with Example 1, except that the mixture should be cured at 15° C. The finished product is a high density, super hard synthetic quartz panel.

### Example 5

| Material Type | Particular Material | Size | Percent by weight |
|---|---|---|---|
| quartz powder | | 1200 mesh | 70 |
| resin | epoxy | | 10 |
| fiber | carbon | | 5 |
| coupling agent | 6F-31 | | 5 |
| curing agent | TBPO | | 5 |
| pigment | | | 5 |

Combine the ingredients indicated in Example 5 according to the given percentages. Manufacture the mixture into panels according to the procedures described above in connection with Example 1, except that the mixture should be cured at 35° C. The finished product is a high density, super hard synthetic quartz panel.

### Example 6

| Material Type | Particular Material | Size | Percent by weight |
|---|---|---|---|
| quartz powder | | 1300 mesh | 50 |
| resin | phenolic | | 15 |
| fiber | glass | | 25 |
| coupling agent | KBM-503 | | 4 |
| curing agent | 3-methyl-6-diamine | | 1 |
| shell chip | | 20 mm | 5 |

### Example 7

| Material Type | Particular Material | Size | Percent by weight |
|---|---|---|---|
| quartz stone | | 10 mm | 47 |
| quartz powder | | 350 mesh | 41.65 |
| resin | UP | | 8 |
| fiber | glass | | 3 |
| coupling agent | KH-570 | | 0.1 |
| curing agent | MEKP | | 0.05 |
| pigment | iron black | | 0.2 |

Combine the ingredients indicated in Examples 6 and 7 according to the given percentages. Manufacture the mixture into panels according to the procedures described above in connection with Example 1, except that the mixture should be heated to and cured at 120° C. The finished product is a high density, super hard synthetic quartz panel.

### Example 8

| Material Type | Particular Material | Size | Percent by weight |
|---|---|---|---|
| quartz powder | | 1400 mesh | 65 |
| resin | acrylic | | 8 |
| fiber | boron | | 18 |
| coupling agent | SH6030 | | 2 |
| curing agent | dihexyltriamine | | 2 |
| metal flake | | 15 mm | 5 |

### Example 9

| Material Type | Particular Material | Size | Percent by weight |
|---|---|---|---|
| quartz stone | | 12 mm | 20 |
| quartz powder | | 700 mesh | 40 |
| resin | UP | | 9.5 |
| fiber | basalt | | 10 |
| coupling agent | KH-570 | | 0.2 |
| curing agent | dihexyltriamine | | 0.1 |
| glass chip | | 8 mm | 10 |
| mirror chip | | | 5 |
| pigment | carbon red | | 0.2 |
| shell chip | | | 2 |
| metal flake | | | 3 |

### Example 10

| Material Type | Particular Material | Size | Percent by weight |
|---|---|---|---|
| quartz powder | | 500 mesh | 32.65 |
| resin | epoxy | | 7 |
| fiber | glass | | 5 |
| coupling agent | Z-6030 | | 0.1 |
| curing agent | ethylenediamine | | 0.05 |
| glass chip | | 10 mm | 55 |
| pigment | iron yellow | | 0.2 |

Combine the ingredients indicated in Examples 8-10 according to the given percentages. Manufacture the mixture into panels according to the procedures described above in connection with Example 1, except that the mixture should be heated to and cured at 60° C. The finished product is a high density, super hard synthetic quartz panel.

### Example 11

| Material Type | Particular Material | Size | Percent by weight |
|---|---|---|---|
| quartz stone | | 0.1 mm | 30 |
| quartz powder | | 600 mesh | 45 |
| resin | phenolic | | 6.7 |
| fiber | glass | | 3 |
| coupling agent | KBM-503 | | 0.1 |
| curing agent | diethylenetriamine | | 0.1 |
| glass chip | | 25 mm | 15 |
| pigment | iron red | | 0.1 |

### Example 12

| Material Type | Particular Material | Size | Percent by weight |
|---|---|---|---|
| quartz stone | | 20 mm | 35 |
| quartz powder | | 800 mesh | 29.5 |
| resin | acrylic | | 8 |
| fiber | glass | | 5 |
| coupling agent | 6F-31 | | 1 |
| curing agent | triethylenebutamine | | 0.5 |
| glass chip | | 0.1 mm | 20 |
| pigment | phthalacyanine green | | 1 |

### Example 13

| Material Type | Particular Material | Size | Percent by weight |
|---|---|---|---|
| quartz stone | | 15 mm | 5 |
| quartz powder | | 1000 mesh | 32.2 |
| resin | PU | | 6.5 |
| fiber | glass | | 5 |
| coupling agent | SH6030 | | 0.1 |
| curing agent | butaethylenepentamine | | 0.1 |
| glass chip | | 9 mm | 51 |
| pigment | phthalacyanine green | | 0.1 |

Combine the ingredients indicated above in Examples 11-13 according to the given percentages. Manufacture the mixture into panels according to the procedures described above in connection with Example 1, except that the mixture should be heated to and cured at 90° C. The finished product is a high density, super hard synthetic quartz panel.

### Example 14

| Material Type | Particular Material | Size | Percent by weight |
|---|---|---|---|
| quartz stone | | 8 mm | 6 |
| quartz powder | | 1500 mesh | 24.1 |
| resin | UP | | 7 |
| fiber | glass | | 7 |
| coupling agent | SH6030 | | 0.2 |
| curing agent | polyethylenepolyamine | | 0.2 |
| glass chip | | 15 mm | 55 |
| pigment | titanium dioxide | | 0.5 |

### Example 15

| Material Type | Particular Material | Size | Percent by weight |
|---|---|---|---|
| quartz stone | | 10 mm | 5.9 |
| quartz powder | | 2000 mesh | 50 |
| resin | PU | | 0.1 |
| fiber | carbon | | 10 |
| coupling agent | KH-570 | | 2 |
| curing agent | dipropyltriamine | | 2 |
| glass chip | | 8 mm | 29 |
| shell chip | | | 1 |

### Example 16

| | | | Percent |
|---|---|---|---|
| Material Type | Particular Material | Size | by weight |
| quartz stone | | 5 mm | 25 |
| quartz powder | | 1800 mesh | 5 |
| resin | epoxy | | 20 |
| fiber | carbon | | 20 |
| coupling agent | KH-570 | | 5 |
| curing agent | dimethylaminepropylamine | | 4 |
| glass chip | | 8 mm | 15 |
| pigment | carbon black | | 5 |
| metal flake | | | 1 |

### Example 17

| | | | Percent |
|---|---|---|---|
| Material Type | Particular Material | Size | by weight |
| quartz stone | | 10 mm | 30 |
| quartz powder | | 1200 mesh | 35.7 |
| resin | phenolic | | 6 |
| fiber | boron | | 3 |
| coupling agent | 6F-31 | | 0.1 |
| curing agent | diethylamihnepropylamine | | 0.1 |
| glass chip | | 2 mm | 15 |
| mirror chip | | | 10 |
| pigment | carbon yellow | | 0.1 |

Combine the ingredients indicated above in Examples 14-17 according to the given percentages. Manufacture the mixture into panels according to the procedures described above in connection with Example 1, except that the mixture should be heated to and cured at 150° C. The finished product is a high density, super hard synthetic quartz panel.

### Example 18

| Material | | | Percent by |
|---|---|---|---|
| Type | Particular Material | Size | weight |
| quartz stone | | 12 mm | 5 |
| quartz powder | | 1400 mesh | 32 |
| resin | PU | | 6.5 |
| fiber | glass | | 5 |
| coupling agent | KH-570 | | 0.3 |
| curing agent | dimenthylaminepropylamine | | 0.1 |
| glass chip | | 9 mm | 51 |
| pigment | phthalocyanine green blue | | 0.1 |

### Example 19

| Material | | | Percent by |
|---|---|---|---|
| Type | Particular Material | Size | weight |
| quartz stone | | 15 mm | 5 |
| quartz powder | | 1000 mesh | 33 |
| resin | epoxy | | 6 |
| fiber | glass | | 5 |
| coupling agent | 6F-31 | | 0.1 |
| curing agent | butethylenepentamine | | 0.1 |
| glass chip | | 7 mm | 50.7 |
| pigment | phthalocyanine green blue | | 0.1 |

### Example 20

| Material | | | Percent by |
|---|---|---|---|
| Type | Particular Material | Size | weight |
| quartz powder | | 500 mesh | 22.65 |
| resin | epoxy | | 7 |
| fiber | glass | | 5 |
| coupling agent | KH-570 | | 0.1 |
| curing agent | ethylenediamine | | 0.05 |
| glass chip | | 10 mm | 55 |
| pigment | ieor yellow | | 0.2 |
| metal flake | alumina hydrate powder | | 10 |

Combine the ingredients indicated above in Examples 18-20 according to the given percentages. The finished product is a high density, super hard synthetic quartz panel. Manufacture the mixture into panels according to the procedures described above in connection with Example 1, except that the mixture should be heated to and cured at 200° C. The finished product is a high density, super hard synthetic quartz panel.

### Performance:

Based on ASTM standards a comparison of examples 7, 15 and 16 with a synthetic quartz product manufactured using conventional processes shows the following results:

TABLE 2

| Physical | ASTM | Conventional | | Example | Example |
|---|---|---|---|---|---|
| property | standard | product | Example 7 | 15 | 16 |
| Tensile | C-648 | 1207 | 2500 | 3500 | 4000 |
| strength (lbs) | | | | | |
| Compressive | C-170 | 22082 | 26000 | 47000 | 68000 |
| strength (psi) | | | | | |
| Flexural | C-880 | 4744 | 6000 | 9500 | 17000 |
| strength (psi) | | | | | |

Based on the above test results, synthetic quartz products according to the invention have physical properties superior to the conventional synthetic quartz stone product. A very practical advantage conferred by the superior properties of synthetic quartz stone products manufactured according to the invention is that they are more resistant to breakage. Prior art synthetic quartz stone products must be shipped on end, whereas the improved synthetic quartz stone products may be shipped horizontally.

There have thus been described certain preferred embodiments of an improved synthetic quartz composition and productions processes therefor. While preferred embodiments have been described and disclosed, it will be recognized by those with skill in the art that modifications are within the true spirit and scope of the invention. The appended claims are intended to cover all such modifications.

We claim:

1. A synthetic quartz composition comprising:
from approximately 5 to approximately 90% quartz powder,
from approximately 0.1 to approximately 20% resin, and
from approximately 1 to approximately 25% fiber,
wherein each of the above percentage ranges indicates proportional weight.

2. The synthetic quartz composition of claim 1 wherein:
said quartz powder has a particle size between approximately 300 to 2000 mesh.

3. The synthetic quartz composition of claim 1 wherein:
said resin is selected from the group consisting of unsaturated polyester resin, epoxy resin, phenolic resin, acrylic resin and polyurethane.

4. The synthetic quartz composition of claim 1 wherein:
said fiber is selected from the group consisting of fiberglass, carbon fiber, basalt fiber and boron fiber.

5. The synthetic quartz composition of claim 1 further comprising:
from approximately 0.1 to approximately 5% coupling agent.

6. The synthetic quartz composition of claim 5 wherein:
said coupling agent comprises an organic silane.

7. The synthetic quartz composition of claim 6 wherein:
said organic silane has the chemical formula RSiX₃ wherein R is an organic radical.

8. The synthetic quartz composition of claim 7 wherein:
said organic radical is selected from the group consisting of amino, sulfhydryl, vinyl, epoxy, cyano, and methacryloxyl radicals.

9. The synthetic quartz composition of claim 6 wherein:
said organic silane has the chemical formula RSiX₃ wherein X is a hydrolytic alkoxy.

10. The synthetic quartz composition of claim 9 wherein:
said hydrolytic alkoxy is selected from the group consisting of methoxy and ethoxy.

11. The synthetic quartz composition of claim 6 wherein:
said organic silane is selected from the group consisting of γ-methacryloxylpropyl-trimethylsilicane, γ-(2,3-epoxypropane)propyl-trimethylsilicane, N-β(aminoethyl)-γ-aminoproplymethyldimethoxysilicane, N-(β-aminoethyl)-γ-aminoproplytrim-ethylsilicane.

12. The synthetic quartz composition of claim 1 further comprising:
from approximately 0.1 to approximately 5% curing agent.

13. The synthetic quartz composition of claim 12 wherein:
said curing agent is selected from the group consisting of methyl ethyl ketone peroxide, ethylenediamine, diethylenetriamine, triethylenebutamine, butaethylenepentamine, polyethylenepolyamine, dipropenetriamine, dimethylaminepropylamine, diethylaminepropylamine, 3-methyl-6-diamine, dihexyltriamine, tert-butyl peroxy-2-ethylhexanoate, and hexamethylenediamine.

14. The synthetic quartz composition of claim 1 further comprising:
up to approximately 90% quartz stones.

15. The synthetic quartz composition of claim 14 further comprising:
said quartz stones are sized between approximately 0.1 to 20 mm.

16. The synthetic quartz composition of claim 15 wherein:
said quartz stones are sized between approximately 0.1 to 12 mm.

17. The synthetic quartz composition of claim 14 further comprising:
glass chip between approximately 15 and 20%,
pigment between approximately 0.1 and 1%,
a coupling agent between approximately 0.1 and 1%, and
a curing agent between approximately 0.1 and 0.5%,
wherein said quartz stones are between approximately 30 and 35%,
said quartz powder is between approximately 45 and 50%,
said resin is between approximately 6 and 8%, and
said fiber is between approximately 3 and 5%.

18. The synthetic quartz composition of claim 14 further comprising:
glass chip between approximately 51 and 55%,
pigment between approximately 0.1 and 0.5%,
a coupling agent between approximately 0.1 and 0.2%, and
a curing agent between approximately 0.1 and 0.2%,
wherein said quartz stones are between approximately 5 and 6%,
said quartz powder is between approximately 32 and 33%,
said resin is between approximately 6.5 and 7%, and
said fiber is between approximately 5 and 7%.

19. The synthetic quartz composition of claim 14 further comprising:
approximately 0.2% pigment,
approximately 0.1% coupling agent,
approximately 0.05% curing agent, and
wherein said quartz stones are approximately 47%,
said quartz powder is approximately 41.65%,
said resin is approximately 8%, and
said fiber is approximately 3%.

20. The synthetic quartz composition of claim 1 further comprising:
chips selected from the group consisting of glass, mirror and shell chips.

21. The synthetic quartz composition of claim 20 wherein:
said chips are sized approximately between 0.1 to 25 mm.

22. The synthetic quartz composition of claim 21 wherein:
said glass chips are up to approximately 70%.

23. The synthetic quartz composition of claim 22 wherein:
said mirror chips are up to approximately 70%.

24. The synthetic quartz composition of claim 23 wherein:
said shell chips are up to approximately 5%.

25. The synthetic quartz composition of claim 1 further comprising:
metal flakes.

26. The synthetic quartz composition of claim 25 wherein:
said metal flakes are sized approximately between 0.1 to 25 mm.

27. The synthetic quartz composition of claim 26 wherein:
said metal flakes are up to approximately 5%.

28. The synthetic quartz composition of claim 1 further comprising:
pigments selected from the group consisting of ferric pigments, phthalocyanine pigments, titanium pigments and carbon pigments.

29. The synthetic quartz composition of claim 1 further comprising:
approximately 55% glass chip,
approximately 0.2% pigment,
approximately 0.1% coupling agent,
approximately 0.05% curing agent, and
said quartz powder is approximately 32.65%,
said resin is approximately 7%, and
said fiber is approximately 5%.

30. A synthetic quartz composition comprising:
from approximately 5 to approximately 90% quartz powder, said quartz powder having a particle size between approximately 300 to 2000 mesh,
from approximately 0.1 to approximately 20% resin, said resin selected from the group consisting of unsaturated polyester resin, epoxy resin, phenolic resin, acrylic resin and polyurethane, and
from approximately 1 to approximately 25% fiber, said fiber selected from the group consisting of fiberglass, carbon fiber, basalt fiber and boron fiber,
wherein each of the above percentage ranges indicates proportional weight.

31. A synthetic quartz composition comprising:
from approximately 5 to approximately 90% quartz powder, said quartz powder having a particle size between approximately 300 to 2000 mesh,
from approximately 0.1 to approximately 20% resin, said resin selected from the group consisting of unsaturated polyester resin, epoxy resin, phenolic resin, acrylic resin and polyurethane,
from approximately 1 to approximately 25% fiber, said fiber selected from the group consisting of fiberglass, carbon fiber, basalt fiber and boron fiber,
up to approximately 90% quartz stones, said quartz stones sized approximately between 0.1 to 20 mm,
up to approximately 70% glass chips,
up to approximately 70% mirror chips,
up to approximately 5% shell chips, said glass, mirror and shell chips sized approximately between 0.1 and 25 mm, and
up to approximately 5% metal flakes, said metal flakes sized approximately between 0.1 and 25 mm,
wherein each of the above percentage ranges indicates proportional weight.

32. The synthetic quartz composition of claim 31 further comprising:
from approximately 0.1 to approximately 5% organic silane for acting as a coupling agent, said organic silane having the chemical formula RSiX₃ wherein R is selected from the group consisting of amino, sulfhydryl, vinyl, epoxy, cyano, and methacryloxyl radicals, and X is a hydrolytic alkoxy selected from the group consisting of methoxy and ethoxy.

33. The synthetic quartz composition of claim 31 further comprising:
an organic silane selected from the group consisting of γ-methacryloxylpropyl-trimethylsilicane, γ-(2,3-epoxypropane)propyl-trimethylsilicane, N-β(aminoethyl)-β-aminoproplymethyldimethoxysilicane, N-(β-aminoethyl)-γ-aminoproplytrim-ethylsilicane.

34. The synthetic quartz composition of claim 31 further comprising:
from approximately 0.1 to approximately 5% curing agent, said curing agent selected from the group consisting of methyl ethyl ketone peroxide, ethylenediamine, diethylenetriamine, triethylenebutamine, butaethylenepentamine, polyethylenepolyamine, dipropenetriamine, dimethylaminepropylamine, diethylaminepropylamine, 3-methyl-6-diamine, dihexyltriamine, tert-butyl peroxy-2-ethylhexanoate, and hexamethylenediamine.

35. A synthetic quartz composition comprising:
from approximately 5 to approximately 90% quartz powder, said quartz powder having a particle size between approximately 300 to 2000 mesh,
from approximately 0.1 to approximately 20% resin, said resin selected from the group consisting of unsaturated polyester resin, epoxy resin, phenolic resin, acrylic resin and polyurethane,
from approximately 1 to approximately 25% fiber, said fiber selected from the group consisting of fiberglass, carbon fiber, basalt fiber and boron fiber,
up to approximately 90% quartz stones, said quartz stones sized approximately between 0.1 to 20 mm,
from approximately 0.1 to approximately 5% organic silane for acting as a coupling agent, said organic silane selected from the group consisting of γ-methacryloxylpropyl-trimethylsilicane, γ-(2,3-epoxypropane)propyl-trimethylsilicane, N-β(aminoethyl)-γ-aminoproplymethyldimethoxysilicane, N-(β-aminoethyl)-γ-aminoproplytrim-ethylsilicane,
from approximately 0.1 to approximately 5% curing agent, said curing agent selected from the group consisting of methyl ethyl ketone peroxide, ethylenediamine, diethylenetriamine, triethylenebutamine, butaethylenepentamine, polyethylenepolyamine, dipropenetriamine, dimethylaminepropylamine, diethylaminepropylamine, 3-methyl-6-diamine, dihexyltriamine, tert-butyl peroxy-2-ethylhexanoate, and hexamethylenediamine,
up to approximately 70% glass chips,
up to approximately 70% mirror chips,
up to approximately 5% shell chips, said glass, mirror and shell chips sized approximately between 0.1 and 25 mm, and
up to approximately 5% metal flakes, said metal flakes sized approximately between 0.1 and 25 mm,
wherein each of the above percentage ranges indicates proportional weight.

36. The synthetic quartz composition of claim 35 wherein:
said quartz powder is approximately 41.65%,
said resin is approximately 8%,
said fiber is approximately 3%,
said quartz stones are approximately 47%,
said coupling agent is approximately 0.1% coupling agent,
said curing agent is approximately 0.05% curing agent, and
said pigment is approximately 0.2% pigment.

37. The synthetic quartz composition of claim 35 wherein:
said quartz powder is approximately 32.65%,
said resin is approximately 7%,
said fiber is approximately 5%,
said coupling agent is approximately 0.1% coupling agent,
said curing agent is approximately 0.05% curing agent,
said glass chip is approximately 55%, and
said pigment is approximately 0.2% pigment.

38. A method for making synthetic quartz comprising:
combining from approximately 5 to approximately 90% quartz powder, from approximately 0.1 to approximately 20% resin, and from approximately 1 to approximately 25% fiber, wherein each of the above percentage ranges indicates proportional weight,
vibrating the combination in a vacuum,
molding the combination into a selected form, and
curing said combination.

39. The method for making synthetic quartz of claim 38 wherein:
said form is a panel.

40. The method for making synthetic quartz of claim 38 wherein:
said form is a sink.

41. The method for making synthetic quartz of claim 38 wherein:
said curing is undertaken at a curing temperature between approximately 10 to 200° C.

42. A method for making synthetic quartz comprising:
combining from approximately 41.65% quartz powder, from approximately 8% UP resin, approximately 3% fiberglass, approximately 47% quartz stones, approximately 0.1% Γ-methacryloxypropyltrimethoxysilane for acting as a coupling agent, approximately 0.05% MEKP to act as a curing agent, and approximately 0.2% iron black pigment, wherein each of the above percentage ranges indicates proportional weight, said quartz powder having a particle size of 350 mesh, and said quartz stones having a size of approximately 10 mm,
vibrating the combination in a vacuum,
molding the combination into a selected form, and
curing said combination at approximately 120° C.

43. A method for making synthetic quartz comprising:
combining from approximately 32.65% quartz powder, from approximately 7% epoxy resin, approximately 0.1% Γ-methacryloxypropyltrimethoxysilane for acting as a coupling agent, approximately 0.05% ethylenediamine to act as a curing agent, approximately 55% fiberglass, and approximately 0.2% iron yellow pigment, wherein each of the above percentage ranges indicates proportional weight, said quartz powder having a particle size of 500 mesh, said quartz stones having a size of approximately 10 mm, and said fiberglass having a particle size of approximately 10 mm,
vibrating the combination in a vacuum,
molding the combination into a selected form, and
curing said combination at approximately 60° C.
